(19) United States
(12) Patent Application Publication
(10) Pub. No.: US 2016/0226279 A1
(43) Pub. Date: Aug. 4, 2016

(54) Portable Power Supply Assembly

(71) Applicant: Willie Anderson, Memphis, TN (US)

(72) Inventor: Willie Anderson, Memphis, TN (US)

(21) Appl. No.: 14/608,867

(22) Filed: Jan. 29, 2015

(51) Int. Cl. H02J 7/00; H01R 13/66

(52) U.S. Cl. CPC H02J 7/0045; H01R 13/6675; H02J 7/0047; H02J 7/0052; H02J 2007/0049; H02J 2007/0059

(57) ABSTRACT

A portable power supply assembly includes a housing that has a pair of electrical sockets positioned thereon and the electrical sockets may be electrically coupled to an external electronic device. A cord is positioned within the housing and the cord is electrically coupled to the electrical sockets. The cord has a distal end with respect to the housing and the distal end has a male plug electrically coupled thereto. The male plug may be electrically coupled to a power source to supply the external electrical device with power. A power supply apparatus is positioned within the housing and the power supply apparatus is electrically coupled to the electrical sockets. The power supply apparatus may be electrically coupled to the power source wherein the power supply apparatus is charged. The power source may provide power to the external electronic device when the cord cannot be electrically coupled to the power source.

### BACKGROUND OF THE DISCLOSURE

### Field of the Disclosure

The disclosure relates to power supply devices and more particularly pertains to a new power supply device for providing electrical power to an external electronic device in a remote location.

### SUMMARY OF THE DISCLOSURE

An embodiment of the disclosure meets the needs presented above by generally comprising a housing that has a pair of electrical sockets positioned thereon and the electrical sockets may be electrically coupled to an external electronic device. A cord is positioned within the housing and the cord is electrically coupled to the electrical sockets. The cord has a distal end with respect to the housing and the distal end has a male plug electrically coupled thereto. The male plug may be electrically coupled to a power source to supply the external electrical device with power. A power supply apparatus is positioned within the housing and the power supply apparatus is electrically coupled to the electrical sockets. The power supply apparatus may be electrically coupled to the power source wherein the power supply apparatus is charged. The power source may provide power to the external electronic device when the cord cannot be electrically coupled to the power source.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a portable power supply assembly according to an embodiment of the disclosure.

FIG. 2 is a bottom perspective view of an embodiment of the disclosure.

FIG. 3 is a top view of an embodiment of the disclosure.

FIG. 4 is a bottom view of an embodiment of the disclosure.

FIG. 5 is a perspective view of an embodiment of the disclosure.

FIG. 6 is a schematic view of an embodiment of the disclosure.

### DESCRIPTION OF THE PREFERRED EMBODIMENT

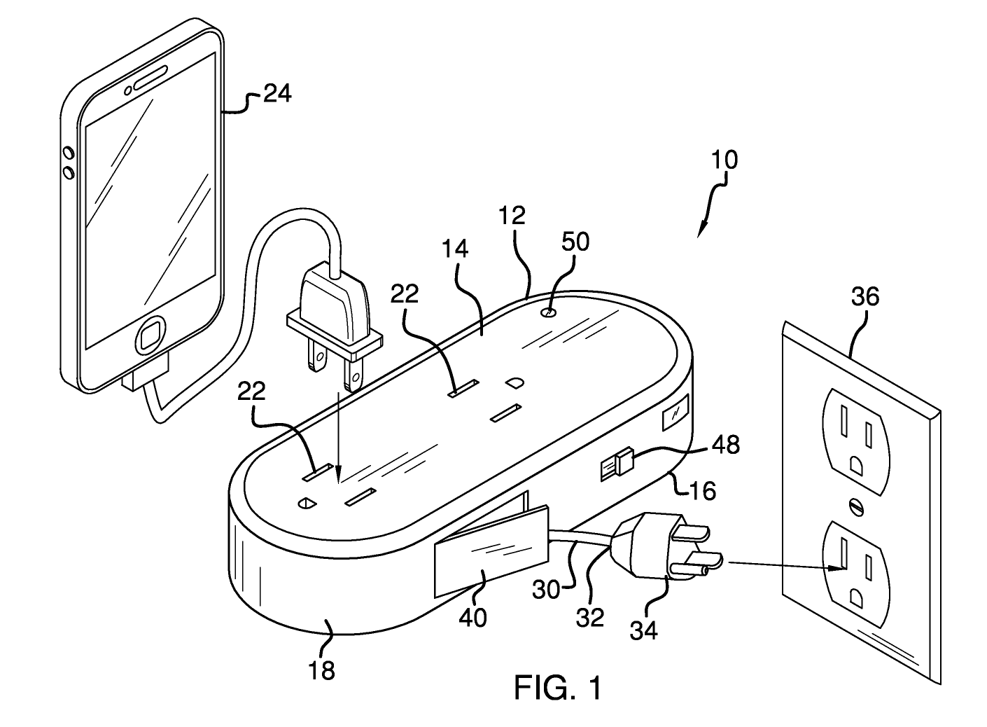

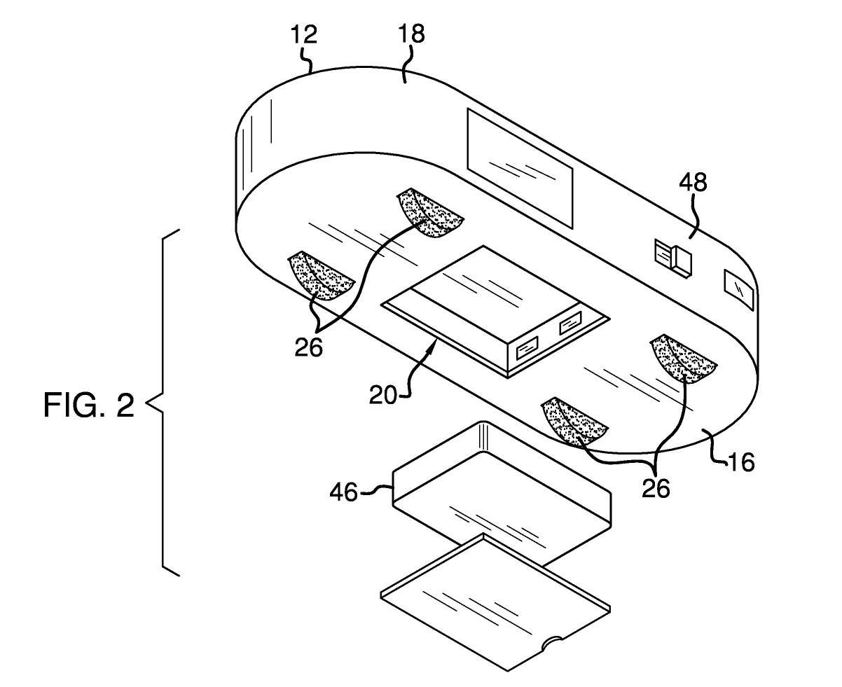

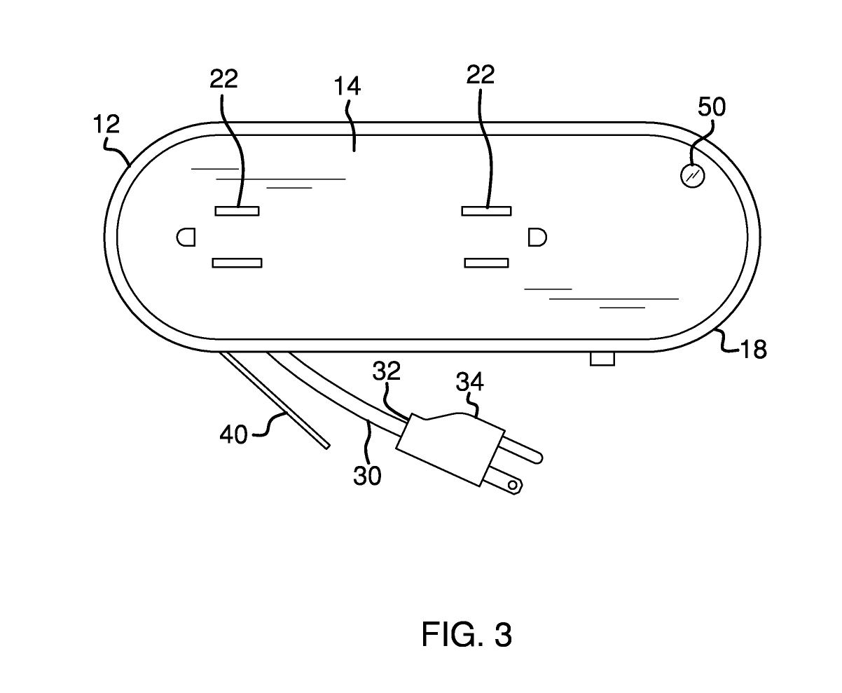

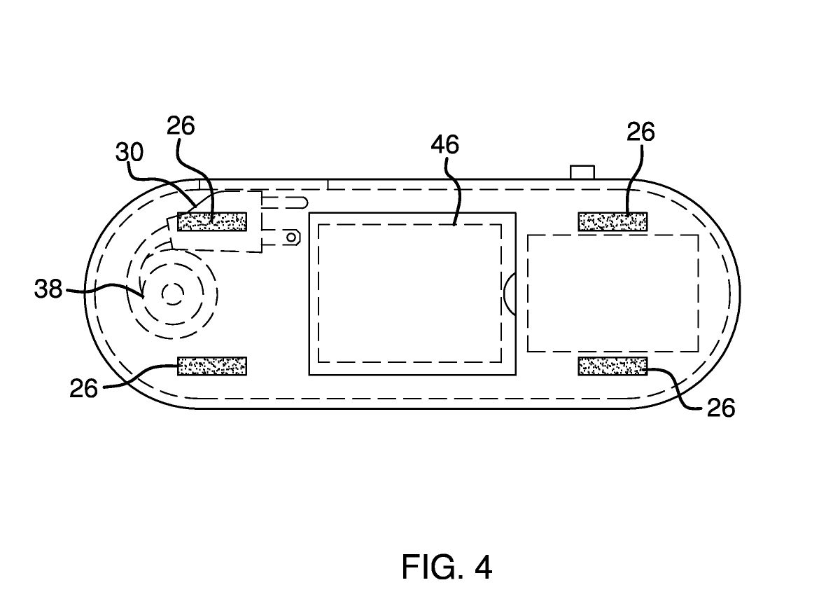

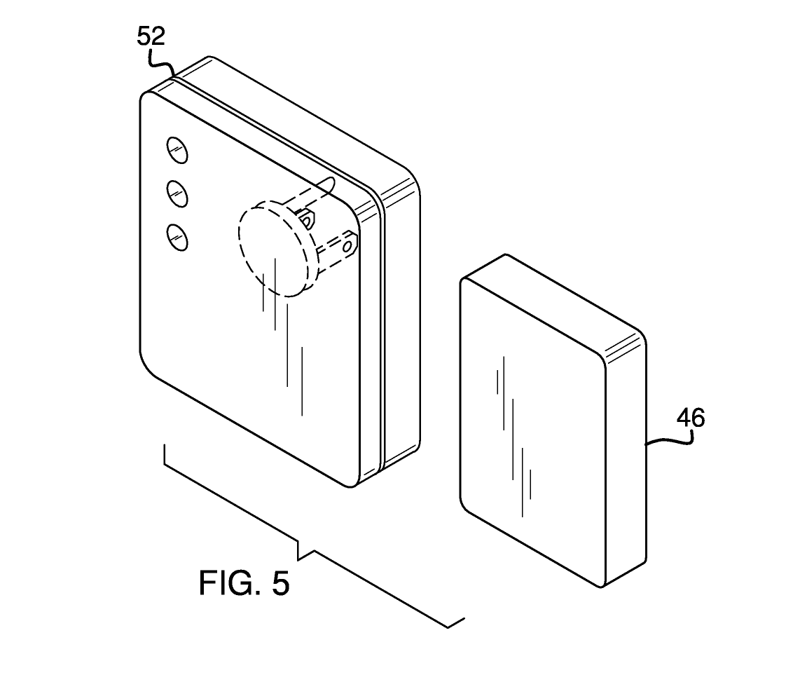

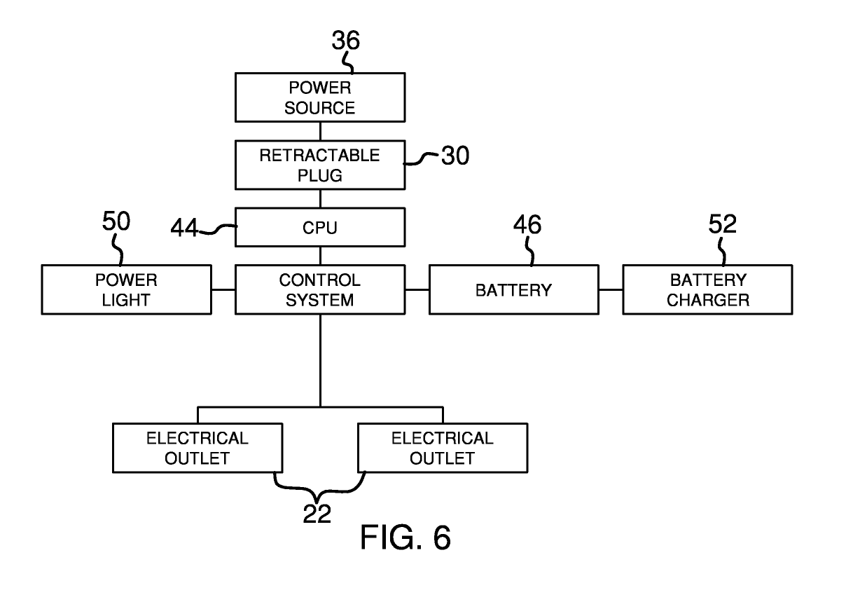

With reference now to the drawings, and in particular to FIGS. 1 through 6 thereof, a new power supply device embodying the principles and concepts of an embodiment of the disclosure and generally designated by the reference numeral 10 will be described.

As best illustrated in FIGS. 1 through 6, the portable power supply assembly 10 generally comprises a housing 12 that has a top wall 14, a bottom wall 16 and a peripheral wall 18 attached to and extending between the top wall 14 and the bottom wall 16. The bottom wall 16 has a well 20 extending upwardly therein and the top wall 14 has a pair of electrical sockets 22 positioned thereon. The electrical sockets 22 may be electrically coupled to an external electronic device 24. The external electronic device 24 may be a laptop computer, a smart phone or any device requiring electrical power. A plurality of feet 26 is coupled to the housing 12 and the feet 26 are positioned on the bottom wall 16. The feet 26 engage a support surface 28.

A cord 30 is positioned within the housing 12 and the cord 30 is electrically coupled to the electrical sockets 22. The cord 30 has a distal end 32 with respect to the housing 12 and the distal end 32 has a male plug 34 electrically coupled thereto. The male plug 34 may be electrically coupled to a power source 36 to supply the external electrical device 24 with power. The power source 36 may be an electrical outlet.

A spool 38 may be positioned within the housing 12 and biased in a conventional manner to rotate in a retracting direction. The spool 38 is urgeable to rotate in a releasing direction and the cord 30 is coupled to and wrapped around the spool 38. The cord 30 may be selectively drawn outwardly from the spool 38 such that the cord 30 extends outwardly from the peripheral wall 18 of the housing 12 when the spool 38 is urged to rotate in the releasing direction. The cord 30 is selectively retracted into the housing 12 when the spool 38 rotates in the retracting direction. A door 40 is hingedly coupled to the peripheral wall 18 of the housing 12. The door 40 covers the cord 30 when the cord 30 is retracted into the housing 12.

A power supply apparatus 42 is positioned within the housing 12 and the power supply apparatus 42 is electrically coupled to the electrical sockets 22. The power supply apparatus 42 may be electrically coupled to the power source 36 to charge the power supply apparatus 42. The power source 36 may provide power to the external electronic device 24 when the cord 40 cannot be electrically coupled to the power source 36. A control circuit 44 is positioned within the housing 12 and the control circuit 44 is electrically coupled to the electrical sockets 22. The control circuit 44 converts a DC voltage to an AC voltage. The control circuit 44 may comprise an inverter of any conventional design.

A battery 46 is removably positioned within the well 20 and the battery 46 is electrically coupled to the control circuit 44 when the battery 46 is positioned within the well 20. The battery 46 may be a Lithium Ion battery or the like. An actuator 48 is coupled to the housing 12 and the actuator 48 is electrically coupled to the control circuit 44 to actuate and de-actuate the control circuit 44.

A light emitter 50 is coupled to the housing 12 and the light emitter 50 is electrically coupled to the control circuit 44. The light emitter 50 emits light when the battery 46 is charged. The light emitter 50 may comprise an LED or the like. A charger 52 is provided that may be electrically coupled to the power source 36. The charger 52 may have the battery 46 electrically coupled thereto after the charger 52 is electrically coupled to the power source 36 such that the charger 52 charges the battery 46. The charger 52 may be a battery charger of any conventional design.

In use, the charger 52 is electrically coupled to the power source 36 and the battery 46 is electrically coupled to the charger 52 until the battery 46 is fully charged. The battery 46 is removed from the charger 52 and placed within the well 20. The housing 12 may be transported to a remote location. The external electronic device 24 is electrically coupled to one of the electrical sockets 22 to supply electrical power to the external electronic device 24. The cord 30 is electrically coupled to the power source 36 when the housing 12 is not in a remote location. The cord 30 supplies electrical power to the electrical sockets 22 while the cord 30 is electrically coupled to the power source 36 thereby allowing the housing 12 to be utilized in the convention of a power strip.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable power supply assembly configured to provide power for an electronic device in a remote location, said assembly comprising:
a housing having a pair of electrical sockets positioned thereon, said electrical sockets being configured to be electrically coupled to an external electronic device;
a cord positioned within said housing, said cord being electrically coupled to said electrical sockets, said cord having a distal end with respect to said housing, said distal end having a male plug electrically coupled thereto, said male plug being configured to be electrically coupled to a power source to supply the external electrical device with power;
a power supply apparatus positioned within said housing, said power supply apparatus being electrically coupled to said electrical sockets, said power supply apparatus being configured to be electrically coupled to the power source wherein said power supply apparatus is charged, said power source being configured to provide power to the external electronic device when said cord cannot be electrically coupled to the power source.

2. The assembly according to claim 1, wherein said housing has a top wall, a bottom wall and a peripheral wall attached to and extending between said top wall and said bottom wall, said bottom wall having a well extending upwardly therein, said top wall.

3. The assembly according to claim 1, further comprising a spool positioned within said housing, said spool being biased to rotate in a retracting direction, said spool being urgeable to rotate in a releasing direction, said cord being coupled to and wrapped around said spool, said cord being selectively drawn outwardly from said spool such that said cord extends outwardly from a peripheral wall of said housing when said spool is urged to rotate in said releasing direction, said cord being selectively retracted into said housing when said spool rotates in said retracting direction.

4. The assembly according to claim 1, wherein said power supply apparatus comprises a control circuit positioned within said housing, said control circuit being electrically coupled to said electrical sockets, said control circuit converting a DC voltage to an AC voltage.

5. The assembly according to claim 4, further comprising:
said housing having a well; and
a battery being removably positioned within said well, said battery being electrically coupled to said control circuit when said battery is positioned within said well.

6. The assembly according to claim 5, further comprising an actuator being coupled to said housing, said actuator being electrically coupled to said control circuit, said actuator actuating and de-actuating said control circuit.

7. The assembly according to claim 6, further comprising a light emitter being coupled to said housing, said light emitter being electrically coupled to said control circuit, said light emitter emitting light when said battery is charged.

8. The assembly according to claim 7, further comprising a charger being configured to be electrically coupled to the power source, said charger having said battery electrically coupled thereto such that said charger charges said battery.

9. The assembly according to claim 1, further comprising a plurality of feet being coupled to said housing, said feet being positioned on said bottom wall, said feet being configured to engage a support surface.

10. A portable power supply assembly configured to provide power for an electronic device in a remote location, said assembly comprising:
a housing having a top wall, a bottom wall and a peripheral wall attached to and extending between said top wall and said bottom wall, said bottom wall having a well extending upwardly therein, said top wall having a pair of electrical sockets positioned thereon, said electrical sockets being configured to be electrically coupled to an external electronic device;
a cord being positioned within said housing, said cord being electrically coupled to said electrical sockets, said cord having a distal end with respect to said housing, said distal end having a male plug electrically coupled thereto, said male plug being configured to be electrically coupled to the power source to supply the external electrical device with power;
a spool being positioned within said housing, said spool being biased to rotate in a retracting direction, said spool being urgeable to rotate in a releasing direction, said cord being coupled to and wrapped around said spool, said cord being selectively drawn outwardly from said spool such that said cord extends outwardly from said peripheral wall of said housing when said spool is urged to rotate in said releasing direction, said cord being selectively retracted into said housing when said spool rotates in said retracting direction;
a power supply apparatus being positioned within said housing, said power supply apparatus being electrically coupled to said electrical sockets, said power supply apparatus being configured to be electrically coupled to the power source wherein said power supply apparatus is charged, said power source being configured to provide power to the external electronic device when said cord cannot be electrically coupled to the power source, said power supply apparatus comprising:
a control circuit being positioned within said housing, said control circuit being electrically coupled to said electrical sockets, said control circuit converting a DC voltage to an AC voltage;
a battery removably being positioned within said well, said battery being electrically coupled to said control circuit when said battery is positioned within said well;
an actuator being coupled to said housing, said actuator being electrically coupled to said control circuit, said actuator actuating and de-actuating said control circuit; and
a light emitter being coupled to said housing, said light emitter being electrically coupled to said control circuit, said light emitter emitting light when said battery is charged; and
a charger being configured to be electrically coupled to the power source, said charger having said battery electrically coupled thereto such that said charger charges said battery; and
a plurality of feet being coupled to said housing, said feet being positioned on said bottom wall, said feet being configured to engage a support surface.
